(19) United States
(12) Patent Application Publication
(10) Pub. No.: US 2026/0280454 A1
(43) Pub. Date: Sep. 17, 2026

(54) Method, System, and Computer Program Product for Calibrating an Actuator

(71) Applicant: BD KIESTRA B.V., Drachten (NL)

(72) Inventors: Jorn Deinum, Stiens (NL); Pieter Broekhuizen, Drachten (NL); Lambertus Gorter, Drachten (NL)

(21) Appl. No.: 19/166,534

(22) PCT Filed: Apr. 12, 2024
(86) PCT No.: PCT/IB2024/053625

§ 371 Date: Sep. 18, 2025

Related U.S. Application Data
(60) Provisional application No. 63/459,404, filed on Apr. 14, 2023.

(51) Int. Cl. H02P 6/16; H02P 6/00; H02P 6/08; H02P 8/22; H02P 8/34

(52) U.S. Cl. CPC H02P 6/16; H02P 6/006; H02P 6/085; H02P 8/22; H02P 8/34; H02P 2203/03

(57) ABSTRACT

Disclosed herein are method, system, and computer program product embodiments for calibrating an actuator. For example, the method may include: controlling an electronically commutated motor to drive an actuator member of the actuator away from a mechanical stop until a reference sensor is triggered by the actuator member; determining a position of the electronically commutated motor at which the actuator member of the actuator triggered the reference sensor; controlling the electronically commutated motor to repeatedly reciprocate the actuator member varying search distances from the position toward the mechanical stop and back to triggering the reference sensor until two reciprocated search distances from the position, which are at least a portion of a commutation step of the electronically commutated motor apart, are detected; and determining, based on the two reciprocated search distances, a distance for accurately positioning the actuator member relative to the mechanical stop.

### CROSS-REFERENCE TO RELATED APPLICATIONS

This application is the United States national phase of International Application No. PCT/IB 2024/053625 filed Apr. 12, 2024, and claims priority to U.S. Provisional Application No. 63/459,404 entitled “Method, System, and Computer Program Product for Calibrating an Actuator” filed Apr. 14, 2023, the disclosures of which are hereby incorporated by reference in their entireties.

### BACKGROUND

Accuracy refers to the ability of an actuator to achieve a commanded position. For example, accuracy is a measure of an error in a commanded position versus an actual position achieved. Existing systems for calibrating actuators may use expensive encoders, require a precisely positioned sensor as a reference, require each actuator unit to be calibrated separately, and/or use components required to meet very tight tolerances to achieve a desired level of actuator accuracy.

### SUMMARY

Accordingly, provided are improved systems, devices, products, apparatus, and/or methods for calibrating an actuator.

According to some non-limiting embodiments or aspects, provided is a method for calibrating an actuator, including: controlling, with at least one processor, an electronically commutated motor to drive an actuator member of the actuator away from a mechanical stop until a reference sensor is triggered by the actuator member; determining, with the at least one processor, a position of the electronically commutated motor at which the actuator member of the actuator triggered the reference sensor; controlling, with the at least one processor, the electronically commutated motor to repeatedly reciprocate the actuator member varying search distances from the position toward the mechanical stop and back to triggering the reference sensor until two reciprocated search distances from the position, which are at least a portion of a commutation step of the electronically commutated motor apart, are detected; and determining, with the at least one processor, based on the two reciprocated search distances, a distance for accurately positioning the actuator member relative to the mechanical stop.

In some non-limiting embodiments or aspects, the at least one processor uses a binary search algorithm to determine the varying search distances.

In some non-limiting embodiments or aspects, the electronically commutated motor includes a stepper motor.

In some non-limiting embodiments or aspects, the electronically commutated motor includes a rotary motor or a linear motor.

According to some non-limiting embodiments or aspects, provided is a method for calibrating an actuator, including: (i) controlling, with at least one processor, an electronically commutated motor to drive an actuator member of the actuator away from a mechanical stop until a reference sensor is triggered by the actuator member; (ii) storing, with the at least one processor, in a memory, a position of the electronically commutated motor at which the actuator member of the actuator triggered the reference sensor; (iii) controlling, with the at least one processor, the electronically commutated motor to drive the actuator member a current search distance from the stored position toward the mechanical stop; (iv) controlling, with the at least one processor, the electronically commutated motor to drive the actuator member from an end of the current search distance toward the reference sensor until the reference sensor is triggered by the actuator member; (v) in response to triggering the reference sensor with the actuator member, comparing, with the at least one processor, a current position of the electronically commutated motor at which the reference sensor is triggered by the actuator member to the stored position of the electronically commutated motor; and (vi) one of: (a) in response to determining that the current position of the electronically commutated motor is different than the stored position of the electronically commutated motor, determining, with the at least one processor, that the actuator member encountered the mechanical stop, decreasing the current search distance a current incremental amount, and repeating steps (iii) (vi); and (b) in response to determining that the current position of the electronically commutated motor is the same as the stored position of the electronically commutated motor, determining, with the at least one processor, whether the actuator member encountered the mechanical stop for the current search distance plus the current incremental amount and one of: (1) in response to determining that the actuator member did not encounter the mechanical stop at the current search distance plus the current incremental amount, increasing, with the at least one processor, the current search distance by the current incremental amount and repeating steps (iii)-(vi); and (2) in response to determining that the actuator member encountered the mechanical stop at the current search distance plus the current incremental amount, determining, with the at least one processor, based on the current search distance and the current search distance plus the current incremental amount, a distance for accurately positioning the actuator member relative to the mechanical stop.

In some non-limiting embodiments or aspects, the current incremental amount includes at least one commutation step of the electronically commutated motor.

In some non-limiting embodiments or aspects, the at least one processor uses a binary search algorithm to determine the current search distance and the current incremental amount.

In some non-limiting embodiments or aspects, the electronically commutated motor includes a stepper motor.

In some non-limiting embodiments or aspects, the electronically commutated motor includes a rotary motor or a linear motor.

In some non-limiting embodiments or aspects, the method further includes: storing, with the at least one processor, in the memory, the distance for accurately positioning the actuator member relative to the mechanical stop.

According to some non-limiting embodiments or aspects, provided is a system, including: at least one processor coupled to a memory and configured to: control an electronically commutated motor to drive an actuator member of an actuator away from a mechanical stop until a reference sensor is triggered by the actuator member; determine a position of the electronically commutated motor at which the actuator member of the actuator triggered the reference sensor; control the electronically commutated motor to repeatedly reciprocate the actuator member varying search distances from the position toward the mechanical stop and back to triggering the reference sensor until two reciprocated search distances from the position, which are at least a portion of a commutation step of the electronically commutated motor apart, are detected; and determine, based on the two reciprocated search distances, a distance for accurately positioning the actuator member relative to the mechanical stop.

In some non-limiting embodiments or aspects, the at least one processor is configured to use a binary search algorithm to determine the varying search distances.

In some non-limiting embodiments or aspects, the electronically commutated motor includes a stepper motor.

In some non-limiting embodiments or aspects, the electronically commutated motor includes a rotary motor or a linear motor.

According to some non-limiting embodiments or aspects, provided is a system, including: at least one processor coupled to a memory and configured to: (i) control an electronically commutated motor to drive an actuator member of an actuator away from a mechanical stop until a reference sensor is triggered by the actuator member; (ii) store, in a memory, a position of the electronically commutated motor at which the actuator member of the actuator triggered the reference sensor; (iii) control the electronically commutated motor to drive the actuator member a current search distance from the stored position toward the mechanical stop; (iv) control the electronically commutated motor to drive the actuator member from an end of the current search distance toward the reference sensor until the reference sensor is triggered by the actuator member; (v) in response to triggering the reference sensor with the actuator member, compare a current position of the electronically commutated motor at which the reference sensor is triggered by the actuator member to the stored position of the electronically commutated motor; and (vi) one of: (a) in response to determining that the current position of the electronically commutated motor is different than the stored position of the electronically commutated motor, determine that the actuator member encountered the mechanical stop, decreasing the current search distance a current incremental amount, and repeating steps (iii)-(vi); and (b) in response to determining that the current position of the electronically commutated motor is the same as the stored position of the electronically commutated motor, determine whether the actuator member encountered the mechanical stop for the current search distance plus the current incremental amount and one of: (1) in response to determining that the actuator member did not encounter the mechanical stop at the current search distance plus the current incremental amount, increase the current search distance by the current incremental amount and repeating steps (iii)-(vi); and (2) in response to determining that the actuator member encountered the mechanical stop at the current search distance plus the current incremental amount, determine, based on the current search distance and the current search distance plus the current incremental amount, a distance for accurately positioning the actuator member relative to the mechanical stop.

In some non-limiting embodiments or aspects, the current incremental amount includes at least one commutation step of the electronically commutated motor.

In some non-limiting embodiments or aspects, the at least one processor is configured to use a binary search algorithm to determine the current search distance and the current incremental amount.

In some non-limiting embodiments or aspects, the electronically commutated motor includes a stepper motor.

In some non-limiting embodiments or aspects, the electronically commutated motor includes a rotary motor or a linear motor.

In some non-limiting embodiments or aspects, the at least one processor is further configured to: store, in the memory, the distance for accurately positioning the actuator member relative to the mechanical stop.

According to some non-limiting embodiments or aspects, provided is a computer program product including at least one non-transitory computer-readable medium including program instructions that, when executed by at least one processor, cause the at least one processor to: control an electronically commutated motor to drive an actuator member of an actuator away from a mechanical stop until a reference sensor is triggered by the actuator member; determine a position of the electronically commutated motor at which the actuator member of the actuator triggered the reference sensor; control the electronically commutated motor to repeatedly reciprocate the actuator member varying search distances from the position toward the mechanical stop and back to triggering the reference sensor until two reciprocated search distances from the position, which are at least a portion of a commutation step of the electronically commutated motor apart, are detected; and determine, based on the two reciprocated search distances, a distance for accurately positioning the actuator member relative to the mechanical stop.

In some non-limiting embodiments or aspects, the program instructions, when executed by the at least one processor, further cause the at least one processor to use a binary search algorithm to determine the varying search distances.

In some non-limiting embodiments or aspects, the electronically commutated motor includes a stepper motor.

In some non-limiting embodiments or aspects, the electronically commutated motor includes a rotary motor or a linear motor.

According to some non-limiting embodiments or aspects, provided is a computer program product including at least one non-transitory computer-readable medium including program instructions that, when executed by at least one processor, cause the at least one processor to: (i) control an electronically commutated motor to drive an actuator member of an actuator away from a mechanical stop until a reference sensor is triggered by the actuator member; (ii) store, in a memory, a position of the electronically commutated motor at which the actuator member of the actuator triggered the reference sensor; (iii) control the electronically commutated motor to drive the actuator member a current search distance from the stored position toward the mechanical stop; (iv) control the electronically commutated motor to drive the actuator member from an end of the current search distance toward the reference sensor until the reference sensor is triggered by the actuator member; (v) in response to triggering the reference sensor with the actuator member, compare a current position of the electronically commutated motor at which the reference sensor is triggered by the actuator member to the stored position of the electronically commutated motor; and (vi) one of: (a) in response to determining that the current position of the electronically commutated motor is different than the stored position of the electronically commutated motor, determine that the actuator member encountered the mechanical stop, decreasing the current search distance a current incremental amount, and repeating steps (iii)-(vi); and (b) in response to determining that the current position of the electronically commutated motor is the same as the stored position of the electronically commutated motor, determine whether the actuator member encountered the mechanical stop for the current search distance plus the current incremental amount and one of: (1) in response to determining that the actuator member did not encounter the mechanical stop at the current search distance plus the current incremental amount, increase the current search distance by the current incremental amount and repeating steps (iii)-(vi); and (2) in response to determining that the actuator member encountered the mechanical stop at the current search distance plus the current incremental amount, determine, based on the current search distance and the current search distance plus the current incremental amount, a distance for accurately positioning the actuator member relative to the mechanical stop.

In some non-limiting embodiments or aspects, the current incremental amount includes at least one commutation step of the electronically commutated motor.

In some non-limiting embodiments or aspects, the program instructions, when executed by the at least one processor, further cause the at least one processor to use a binary search algorithm to determine the current search distance and the current incremental amount.

In some non-limiting embodiments or aspects, the electronically commutated motor includes a stepper motor.

In some non-limiting embodiments or aspects, the electronically commutated motor includes a rotary motor or a linear motor.

In some non-limiting embodiments or aspects, the program instructions, when executed by the at least one processor, further cause the at least one processor to store, in the memory, the distance for accurately positioning the actuator member relative to the mechanical stop.

### BRIEF DESCRIPTION OF THE DRAWINGS

The accompanying drawings are incorporated herein and form a part of the specification.

FIG. 1 is a diagram of non-limiting embodiments or aspects of an environment in which systems, devices, products, apparatus, and/or methods, described herein, may be implemented;

FIG. 2A illustrates an exemplary stepper motor in a rotary application, in accordance with aspects of the disclosure.

FIGS. 2B and 2C illustrate an exemplary stepper motors in a linear application, in accordance with aspects of the disclosure.

FIG. 2D illustrates an exemplary brushless direct current (BLDC) motor, in accordance with aspects of the disclosure.

FIG. 2E illustrates an exemplary stepper motor, in accordance with aspects of the disclosure.

FIG. 3 illustrates an exemplary linear actuator, in accordance with aspects of the disclosure.

FIGS. 4A-4C illustrate exemplary electronically commutated linear motors, in accordance with aspects of the disclosure.

FIG. 5 is a flowchart of non-limiting embodiments or aspects of a process for calibrating an actuator;

FIG. 6 is a flowchart of non-limiting embodiments or aspects of a process for calibrating an actuator;

FIG. 7 is a graph of a binary search plot.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for calibrating an actuator (and/or measuring a distance to a mechanical stop or other obstruction). Non-limiting embodiments or aspects of the present disclosure may control an electronically commutated motor to drive an actuator member of the actuator away from a mechanical stop until a reference sensor is triggered by the actuator member; determine a position of the electronically commutated motor at which the actuator member of the actuator triggered the reference sensor; control the electronically commutated motor to repeatedly reciprocate the actuator member varying search distances from the position toward the mechanical stop and back to triggering the reference sensor until two reciprocated search distances from the position, which are at least a portion of a commutation step of the electronically commutated motor apart, are detected (e.g., one reciprocated search distance has an equal forward and return distance and the other reciprocated search distance has a smaller return distance than the forward distance, etc.); and control based on the two reciprocated search distances, a distance for accurately positioning the actuator member relative to the mechanical stop. For example, when an outbound distance no longer matches a return distance for a reciprocated search, it may determined that there is an obstruction (e.g., the mechanical stop, etc.) blocking the motion of the actuator member or axis (e.g., which causes the rotor to snap back to a previous commutation step or position even though a driving sine wave is counted for the distance in the forward direction, thereby causing the return distance, in which the obstruction is not encountered, to be at least one driving sine wave less than the forward distance, etc.). As an example, a rotor of the electronically commutated motor (or coils of a forcer of a linear motor) is configured to settle in an orientation in which the magnets of the motor are aligned with the magnetic fields of the stator or coils. In such an example, an external force can offset the rotor (or coils) and thus the orientation of the magnets relative to the magnetic fields of the stator or coils. By increasing the offset of the rotor (or coils), the force of the intended magnetic field may reduce, and the force from the adjacent magnetic field magnets may increase. If the rotor (or coils) is offset so far that the force from the adjacent magnetic field is larger than the intended magnetic field, the rotor (or coils) snap towards that adjacent magnetic field, if physically possible. Accordingly, by using an iterative calibration method according to non-limiting embodiments or aspects, the offset between the magnetic fields and the mechanical end stop may be found to the accuracy of at least a portion or fraction of the commutative step size (e.g., to microstep precision of a stepper motor, etc.).

In this way, non-limiting embodiments or aspects of the present disclosure may enable accurately calibrating an actuator member or axis to a mechanical stop (and/or measuring a distance to an obstruction) without a need for an encoder (or similar a position detection) and without a need for a precisely positioned reference sensor (e.g., relative to other components, etc.), by determining a relative position of the mechanical stop to a commutation error of an electronically commutated motor driving the actuator. Accordingly, non-limiting embodiments or aspects of the present disclosure may (i) provide for accuracy differences between actuator assemblies to be compensated without a need for manual calibration, (ii) achieve a high level of accuracy with a low accuracy (e.g., a low cost) sensor, (iii) provide a cost effective replacement for encoder-controlled actuator calibration, (iv) be less susceptible to interference due to omission of an encoder, (v) provide greater design freedom during development, (vi) enable retroactive calibration of any device in field that includes a reference sensor, and/or the like.

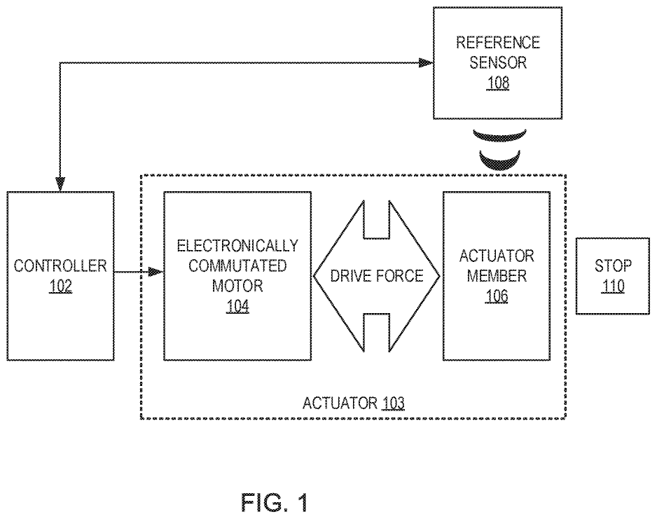

Referring now to FIG. 1, FIG. 1 is a diagram of an example environment 100 in which devices, systems, methods, and/or products described herein, may be implemented. As shown in FIG. 1, environment 100 includes controller 102, actuator 103 including electronically commutated motor 104 and/or actuator member 106, reference sensor 108, and/or mechanical stop 110.

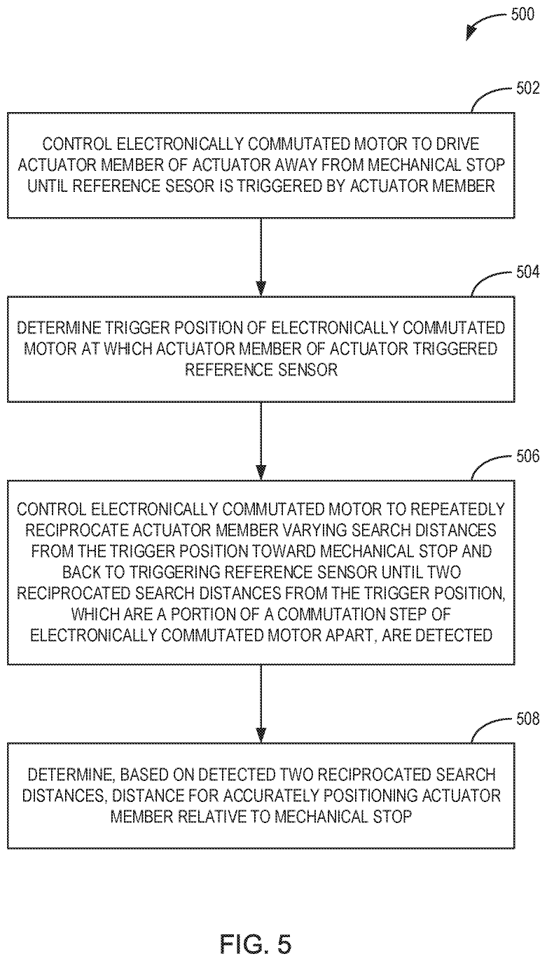

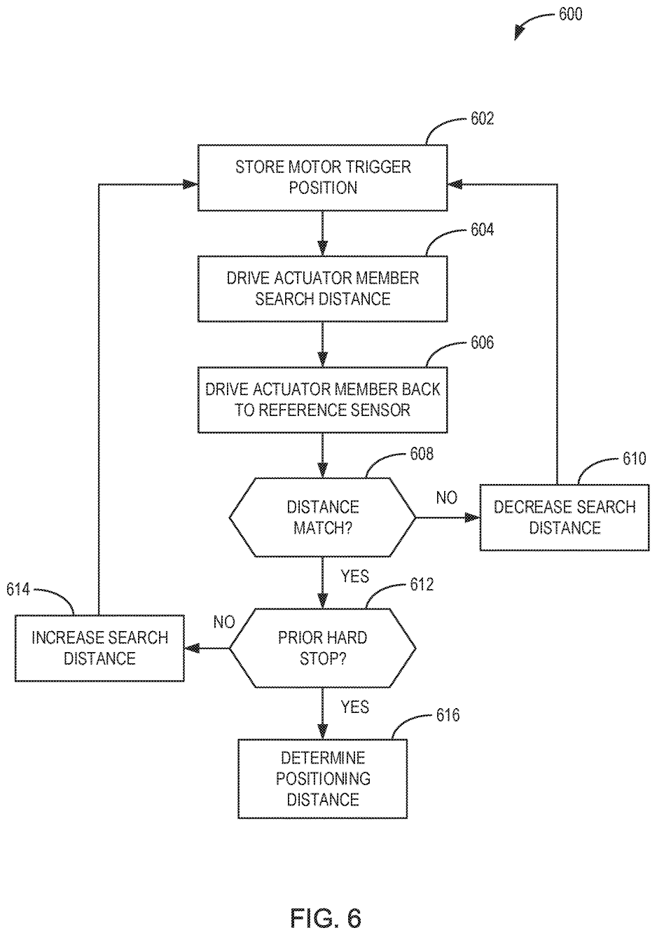

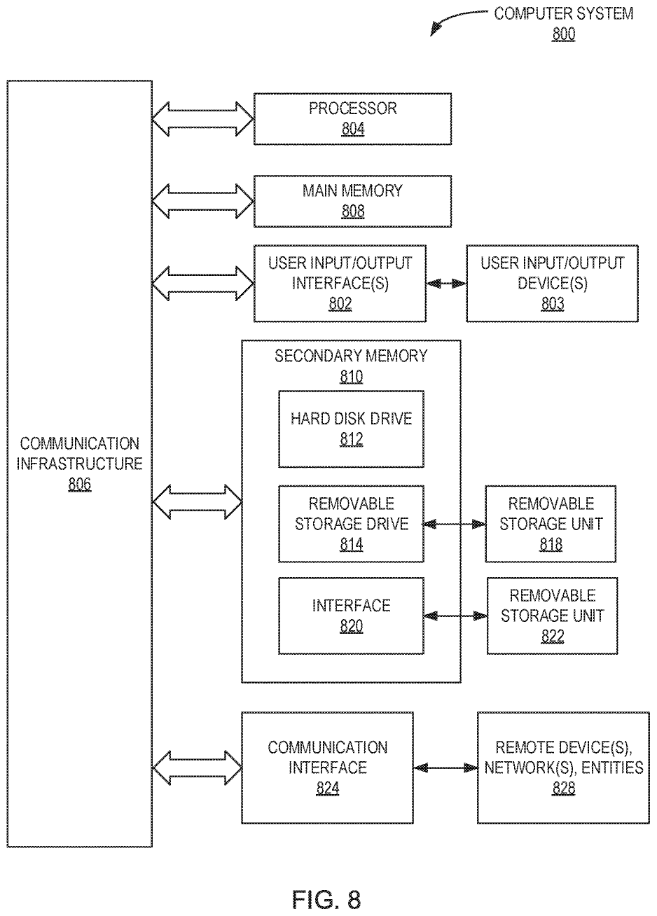

Controller 102 may include at least one processor coupled to a memory, such as a microcontroller (e.g., a low power microcontroller unit (MCU), etc.), and/or the like. For example, controller 102 may include one or more components of computer system 800 shown in FIG. 8. Controller 102 may be configured to control operations of actuator 103 as described herein in more detail with respect to FIGS. 5 and 6.

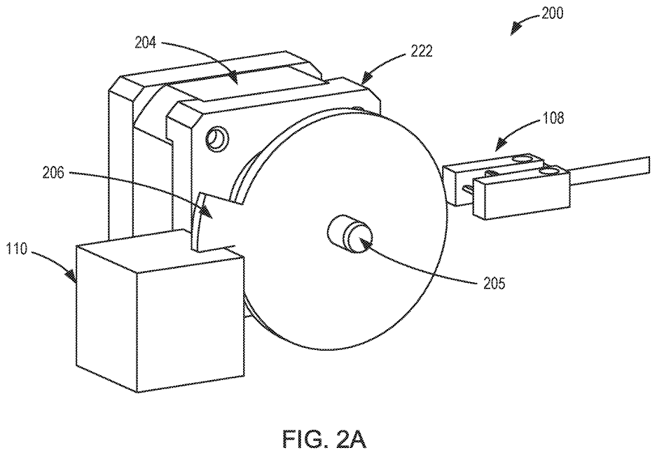

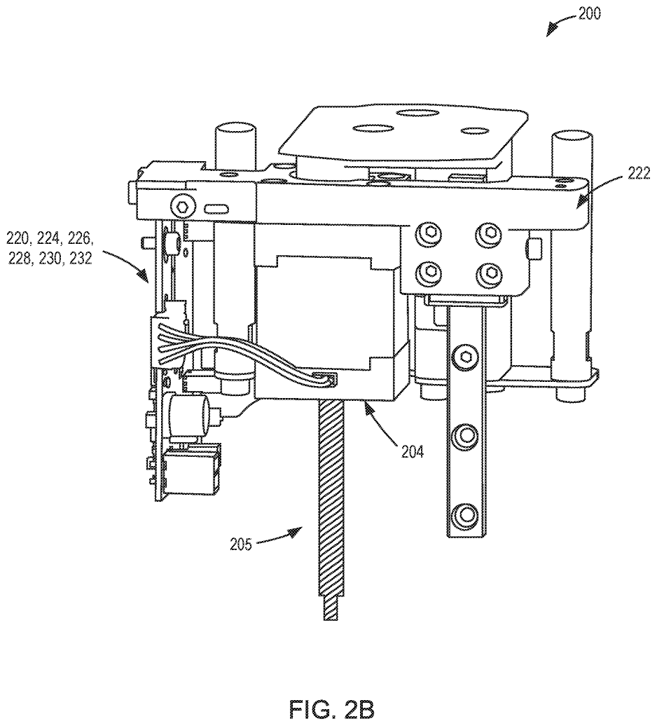

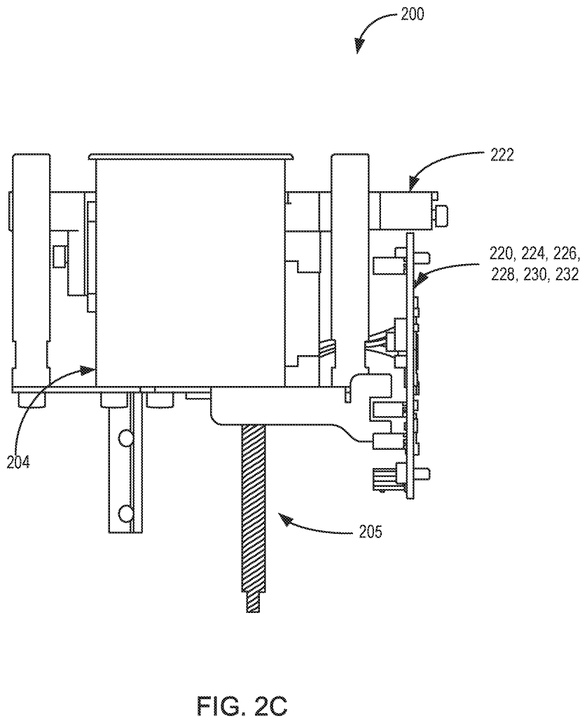

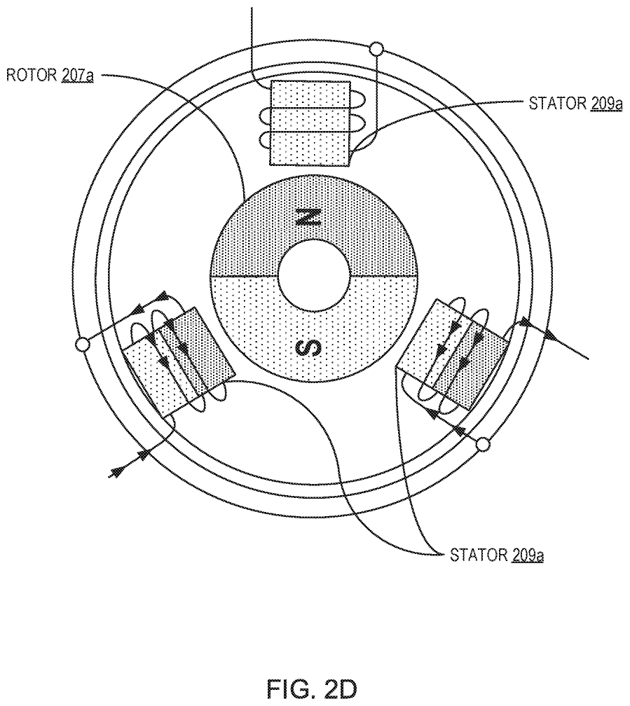

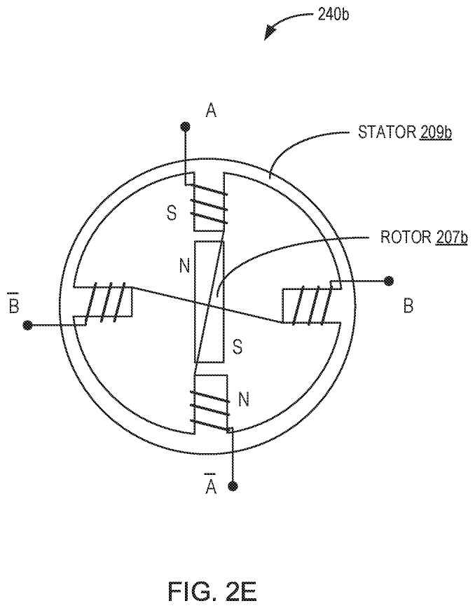

In some non-limiting embodiments or aspects, for example, as shown in FIGS. 2B and 2C, controller 102 may be implemented as a printed circuit board assembly (PCBA) 220, which may be connected or mounted to an interior or exterior surface of a housing or frame of actuator 103, such as housing or frame 222 of actuator 200. For example, PCBA 220 may include processor 224 (e.g., a low power MCU, etc.), memory 226 (e.g., a main memory 808, a secondary memory 810, etc.) wireless communication circuitry 228, power source 230, and/or a user input/feedback device 232.

Wireless communication circuitry 228 may be configured to wirelessly communicate (e.g., via a short range wireless communication connection, such as an NFC communication connection, an RFID communication connection, a Bluetooth® communication connection, and/or the like, etc.) information and/or data (e.g., actuator control commands, motor positions, calibration values, etc.) with an external computing device. Wireless communication circuitry 228 may be configured to establish communication with an external computing device (e.g., to pair and/or activate a pairing sequence for pairing with the external computing device, etc.) based on a predetermined user input to user input/feedback device 232 (e.g., in response to a user pressing and/or holding a button, etc.).

Power source 230 may include a rechargeable battery, a single use battery, a replaceable battery, a connection to an external power source, or any combination thereof. In some non-limiting embodiments or aspects, power source 230 may include an energy harvester (e.g., a thermoelectric energy harvester, a photovoltaic energy harvester, a piezoelectric energy harvester, etc.). Power source 230 may be configured to provide power for operating components of PCBA 220 and/or electronically commutated motor 104 (e.g., for driving actuator member 106, etc.).

User input/feedback device 232 may be configured to receive a user input from a user and/or to provide feedback to the user. For example, user input/feedback device 232 may include at least one of the following: a button, a display, a light-emitting diode (LED), an audio output device (e.g., a buzzer, a speaker, etc.), or any combination thereof.

Actuator 103 may include a linear actuator, a rotary actuator, any combination thereof, and/or the like. For example, actuator 103 may include an actuator configured to adjust a nozzle of a 3D printer with respect to a printer bed or plate (e.g., a printing surface, etc.) of the 3D printer, and/or to adjust the printer bed or plate with respect to the nozzle, to ensure that the nozzle is accurately positioned with respect to the bed or plate. As an example, actuator 103 may include an actuator configured to adjust one or more components of a microbiology plate station to ensure that the microbiology plates and corresponding components for inoculation, incubation, plate imaging, handling, transportation, and/or reading are accurately positioned with respect to each other. For example, non-limiting embodiments or aspects of the present disclosure may be used to calibrate one or more actuators of an automated specimen processing system (to one or more stops, obstructions, or other components thereof) as described in International Publication No. WO 2021/1808836, published Sep. 16, 2021, the entire contents of which are hereby incorporated by reference. Further details regarding non-limiting embodiments or aspects of actuator 103 are provided below with regard to FIGS. 2A-2E, 3, and 4A-4C.

Electronically commutated motor 104 may include a brushless direct current (BLDC) motor, a stepper motor, a rotary motor, a linear motor (e.g., an iron core linear motor, an ironless or U-channel linear motor, a slotless linear motor, a tubular linear motor, etc.), and/or the like. Further details regarding non-limiting embodiments or aspects of electronically commutated motor 104 are provided below with regard to FIGS. 2A-2E, 3, and 4A-4C.

Reference sensor 108 may include at least one of the following sensors: a photoelectrical sensor (e.g. a visible light sensor, an infrared (IR) light sensor, a ultraviolet (UV) light sensor etc.), such as a U-shape sensor (e.g.,. a Panasonic PM-Y45-P, an Omron EE-SX4350, an Omron EE-SX3340, etc.), a beam break sensor, and/or the like; a mechanical sensor (e.g., a switch, a micro switch, a strain sensor, a load cell, etc.); a proximity sensor (e.g., an ultrasonic sensor, an induction sensor (e.g., a Festo SIED-M12B-ZS-K-L-PA, etc.), a Hall Effect sensor, a capacitive sensor, an eddy current sensor, etc.); an encoder (e.g., if a resolution of the encoder is coarser than a desired or required precision, etc.); any combination thereof; and/or the like.

Reference sensor 108 may be configured to be triggered by a presence of actuator member 106 (e.g., configured to detect a position of actuator member 106 at reference sensor 108, etc.). Reference sensor 108 may be held at a stationary position relative to mechanical stop 110. For example, a distance and orientation of reference sensor to mechanical stop may be consistent or unchanging. However, reference sensor 108 need not be precisely positioned with respect to mechanical stop 110 and/or other components of actuator 103. For example, reference sensor 108 may be positioned at any location along a travel path of actuator member 106.

Mechanical stop 110 may include a rigid mechanical stop or obstruction configured to inhibit or block the movement or travel of actuator member 106 (and thereby the movement of a rotor or forcer of electronically commutated motor 104) in a direction away from reference sensor 108 when mechanical stop 110 is encountered by actuator member 106. For example, mechanical stop 110 may be secured to a housing or frame of actuator 103, such as housing or frame 222 of rotary actuator 200 as shown in FIG. 2A.

Referring now to FIGS. 2A-2C, FIGS. 2A-2C illustrate an exemplary rotary actuator 200, in accordance with aspects of the disclosure. As shown in FIGS. 2A-2C, actuator member 206 may be mechanically connected to electronically commutated rotary motor 204 (e.g., to rotor 207a of BLDC motor 204a shown in FIG. 2D, to rotor 207b of stepper motor 204b as shown in FIG. 2E, etc.) via lead screw 205.

Referring also to FIG. 2D, which illustrates an exemplary BLDC motor 204a, in accordance with aspects of the disclosure, rotor 207a may include a permanent magnet, and stator coils 209a of BLDC motor 204a may not rotate, but may instead be fixed in place on the stator. Rotation may be achieved by changing the direction of the magnetic fields generated by the surrounding stationary stator coils, and/or controller 102 may control the rotation by adjusting the magnitude and/or direction of the current into the stator coils. Although shown as having three stator coils and a single permanent magnet pair in FIG. 2D, non-limiting embodiments or aspects of the present disclosure are not limited thereto and BLDC motor 204a may include any desired number of phases (e.g., one-phase motor, a two-phase motor, a three-phase motor, etc.) and/or be configured with a commutation sequence including any desired number of commutation steps (e.g., 6 steps, 32 steps, 64 steps, 1024 steps, etc.).

Referring also to FIG. 2E, which illustrates an exemplary stepper motor, in accordance with aspects of the disclosure, rotor 207b may include a permanent magnet, and when current flows through the stator winding 209b, stator winding 209b produces a vector magnetic field. The magnetic field may drive rotor 207b to rotate by an angle so that the pair of magnetic fields of the rotor 207b and the magnetic field direction of the stator 209b are consistent. When the vector magnetic field of stator 209b is rotated by an angle, rotor 207b also rotates with the magnetic field at an angle. Each time an electrical pulse is input, rotor 207b rotates one degree further. The angular displacement that rotor 207b outputs is proportional to the number of pulses input and the speed is proportional to the pulse frequency. Changing the order of winding power may reverse the motor. In this way, controller 102 may control the rotation of stepper motor 204b by controlling the number of pulses, the frequency and the electrical sequence of each phase winding of the motor.

In some non-limiting embodiments or aspects, controller 102 may drive stepper motor 204b using microstepping. For example, microstepping is driving a stepper motor at less the one full step per movement. As an example, a stepper motor may operate by turning one full step with each pulse of current. Microstepping allows a motor to make far finer steps by having controller 102 send the proper kinds of current pulses to the stepper motor. For example, controller 102 may not send a full pulse of current to the stepper motor to make it move and instead send only partial pulses to the stepper motor. As a result, the motor spins only a fraction of a step. Example values of microstepping are 16 to 64 microsteps per one full step. For a 1.8° stepper motor, this makes for steps from 0.1124° to 0.028°. As an example, controller 102 may send current to the motor as stepped sine waves. The steps in the sine wave pattern are the individual microsteps and the whole wavelength is a pulse that turns the motor one full step.

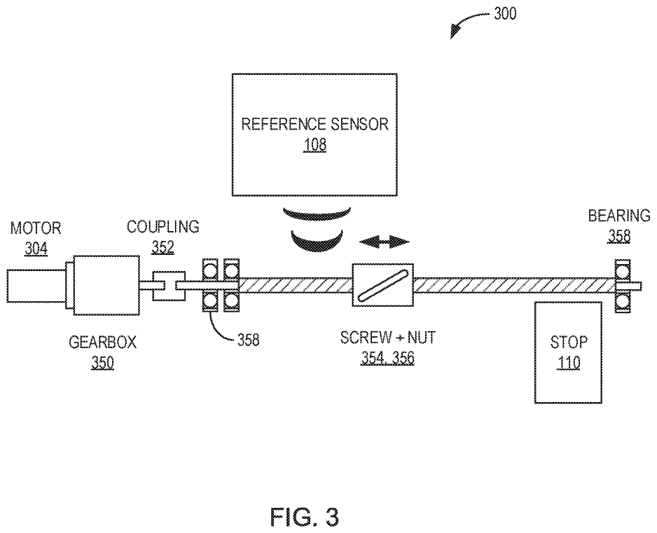

Referring now to FIG. 3, FIG. 3 illustrates an exemplary linear actuator 300, in accordance with aspects of the disclosure. As shown in FIG. 3, linear actuator 300 may include a rotary motor 304, which may be the same or similar as electronically commutated rotary motor 204, gearbox 350, coupling 352, screw 354, nut 356 (e.g., actuator member 106, etc.), and/or bearings 358. Linear actuator 300 may be configured to drive nut 356 or actuator member 106 via gearbox 350 and coupling 352 in a straight line along screw 354 between bearings 358 at each end of screw 354. For example, rotary motor 304 may be used as a source of actuation in conjunction with a lead or ball screw to create the linear motion. In such an example, reference sensor 108 may be positioned at a location between bearings 358 and mechanical stop 110.

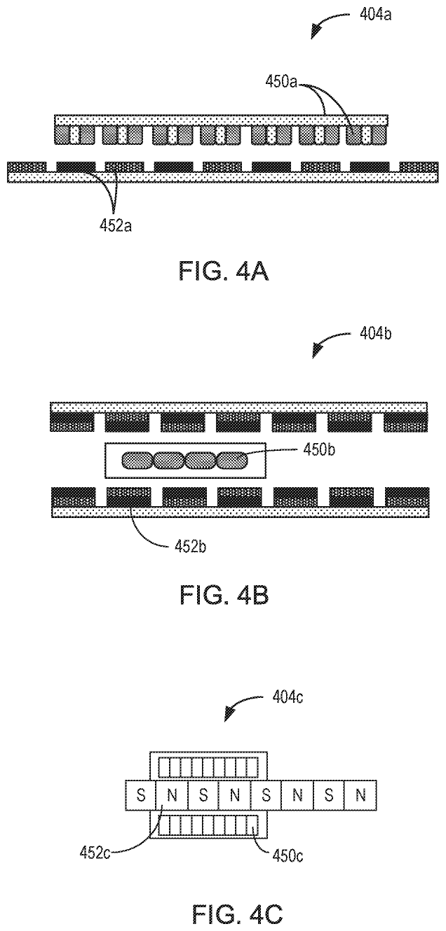

Referring now to FIGS. 4A-4C, FIGS. 4A-4C illustrate exemplary electronically commutated linear motors 404a, 404b, and 404c, in accordance with aspects of the disclosure. As shown in FIG. 4A, electronically commutated linear motor 404a may include three-phase electromagnetic coils that are wound around an iron core (teeth) of laminations on forcer 450a and track 452a including permanent magnets. As shown in FIG. 4B, electronically commutated linear motor 404b may include an ironless linear motors (e.g., U-channel linear motor, etc.) and electromagnetic coil windings that are mounted in epoxy rather than iron lamination stack on forcer 450b and track 452b including permanent magnets. A slotless linear motor (not shown) may combine design elements of iron core motors and ironless motors. As shown in FIG. 4c, electronically commutated linear motor 404c may include tubular linear motor including a coil winding (e.g., a three-phase coil winding, etc.) on forcer 450c including coils surrounding cylinder-shaped magnets shaft or track 452c including permanent magnets. Forcers 450a, 450b, and 450c of electronically commutated linear motors 404a, 404b, and 404c may operate as and/or apply a driving force to actuator member 106 to move actuator member 106 forwards and/or backwards along track 452a, 452b, and 452c. In non-limiting embodiments or aspects of the present disclosure, electronically commutated linear motors 404a, 404b, and 404c may include any desired number of phases (e.g., one-phase motor, a two-phase motor, a three-phase motor, etc.) and/or be configured with a commutation sequence including any desired number of commutation steps (e.g., 6 steps, 32 steps, 64 steps, 1024 steps, etc.).

The number and arrangement of devices and systems shown in FIGS. 1, 2A-2E, 3, and 4A-4C is provided as an example. There may be additional devices and/or systems, fewer devices and/or systems, different devices and/or systems, or differently arranged devices and/or systems than those shown in FIGS. 1, 2A-2E, 3, and 4A-4C. Furthermore, two or more devices and/or systems shown in FIGS. 1, 2A-2E, 3, and 4A-4C may be implemented within a single device and/or system, or a single device and/or system shown in FIGS. 1, 2A-2E, 3, and 4A-4C may be implemented as multiple, distributed devices and/or systems. Additionally, or alternatively, a set of devices and/or systems (e.g., one or more devices or systems) of environment 100 may perform one or more functions described as being performed by another set of devices and/or systems of environment 100.

Referring now to FIG. 5, FIG. 5 is a flowchart of non-limiting embodiments or aspects of a process 500 for calibrating an actuator.

As shown in FIG. 5, at step 502, process 500 includes controlling an electronically commutated motor to drive an actuator member of the actuator away from a mechanical stop until a reference sensor is triggered by the actuator member. For example, controller 102 may control electronically commutated motor 104 to drive actuator member 106 of actuator 103 away from mechanical stop 110 (and/or toward reference sensor 108) until reference sensor 108 is triggered by actuator member 106. As an example, when a calibration sequence of actuator 103 is started with controller 102, controller 102 may determine whether reference sensor 108 is already triggered by actuator member 106. If reference sensor 108 is not already triggered by actuator member 106, controller 102 may control electronically commutated motor 104 to drive actuator member 106 of actuator 103 away from mechanical stop 110 (and/or toward reference sensor 108) until reference sensor 108 is triggered by actuator member 106. In such an example, if reference sensor 108 is already triggered by actuator member 106, controller 102 may read the stored position from member as described herein in more detail.

As shown in FIG. 5, at step 504, process 500 includes determining a position of the electronically commutated motor at which the actuator member of the actuator triggered the reference sensor. For example, controller 102 may determine a position (e.g., a trigger position, a stored position, etc.) of electronically commutated motor 104 at which actuator member 106 of the actuator 103 triggered reference sensor 108. As an example, controller 102 may store, in a memory, the position of electronically commutated motor 104 at which actuator member 106 of the actuator 103 triggered reference sensor 108. In such an example, a position of electronically commutated motor 104 at which actuator member 106 of the actuator 103 triggered reference sensor 108 may include a commutation step and/or at least a portion thereof in a commutation sequence of electronically commutated motor 104 at which actuator member 106 of the actuator 103 triggered reference sensor 108 (e.g., a relative position of a stator and a rotor for a rotary motor (or a relative position of forcer coils and a permanent magnet track of a linear motor). For example, controller 102 may determine the position based on an electromotive force (EMF) that gives rise to a current in the windings or coils with a magnetic field that opposes the original change in magnetic flux as described by Lenz's Law and discussed in further detail herein.

Further details regarding non-limiting embodiments or aspects of step 504 of process 500 are provided below with regard to FIG. 6.

As shown in FIG. 5, at step 506, process 500 includes controlling the electronically commutated motor to repeatedly reciprocate the actuator member varying search distances from the position toward the mechanical stop and back to triggering the reference sensor until two reciprocated search distances from the position, which are at least a portion of a commutation step of the electronically commutated motor apart, are detected. For example, controller 102 may control electronically commutated motor 104 to repeatedly reciprocate actuator member 106 varying search distances from the position (e.g., the trigger position, the stored position, etc.) toward mechanical stop 110 and back to triggering reference sensor 108 until two reciprocated search distances from the position, which are at least a portion of a commutation step of electronically commutated motor 104 apart, are detected. As an example, a first distance of the two distances may be a largest reciprocated search distance at which the forward and the return distance are equal, and a second distance of the two distances may be a shorter reciprocated search distance at which the return distance is smaller than the forward distance. In such an example, the return distance may be shorter than the forward distance by at least a portion of a commutation step of electronically commutated motor 104 (e.g., by a sine wave period of the alternating stator current, etc.). In such an example, controller 102 may set a torque and/or a speed of electronically commutated motor 104 to limit or prevent mechanical deformation of actuator member 106 upon encountering mechanical stop 110 and/or to maintain a consistent and predictable operation.

Controller 102 may determine the forward and return distances by counting a number of sine waves (or microsteps) driving the stator coils of electronically commutated motor 104. For example, each sine wave (e.g., one full period of each single sine wave, etc.) may correspond to a commutation step of electronically commutated motor 104. As an example, controller 102 may include a Texas Instruments DRV10983-Q1 and/or the like that provides single-chip sensorless control of a BLDC motor with sinusoidal commutation and either digital or analog control, in which the commutation control algorithm continuously measures the motor phase current and periodically measures the VCC supply voltage and uses this information to estimate the value of BEMF, and makes this value available over an I2C interface for external use.

Controller 102 may determine the forward and return distances using the EMF that gives rise to a current in the windings or stators with a magnetic field that opposes the original change in magnetic flux as described by Lenz's Law. The EMF tends to resist the rotation of the motor and may therefore be referred to as “back” EMF. For a given motor of fixed magnetic flux and number of windings, the EMF may be proportional to the angular velocity of the rotor. By monitoring the back EMF, controller 102 can determine the relative positions of the stator and rotor without a need for Hall-effect sensors, which may simplify motor construction, reduce cost as well as eliminate additional wiring and connections to the motor that would otherwise be needed to support the sensors, thereby improving reliability.

Further details regarding non-limiting embodiments or aspects of step 506 of process 500 are provided below with regard to FIG. 6.

As shown in FIG. 5, at step 508, process 500 includes determining, based on the two reciprocated search distances, a distance for accurately positioning the actuator member relative to the mechanical stop. For example, controller 102 may determine, based on the two reciprocated search distances, a distance for accurately positioning actuator member 106 relative to mechanical stop 110. As an example, controller 102 may store, in the memory, the distance for accurately positioning the actuator member relative to the mechanical stop (e.g., as a calibrated value, etc.). In such an example, controller 102 may calculate the distance based on a distance of the current motor position (e.g., at the trigger position, etc.) to mechanical stop 110 and subtracting half a stator current phase and the compression of the system (e.g., a flex in actuator member 106, a transmission inaccuracy, etc.) from the determined distance.

Referring now to FIG. 6, FIG. 6 is a flowchart of non-limiting embodiments or aspects of a process 500 for calibrating an actuator.

As shown in FIG. 6, at step 602, process 600 includes storing, in a memory, a position of the electronically commutated motor at which the actuator member of the actuator triggered the reference sensor. For example, controller 102 may store, in a memory, a position (e.g., a trigger position, a stored position, etc.) of electronically commutated motor 104 at which actuator member 106 of actuator 103 triggered reference sensor 108. As an example, controller 102 may control electronically commutated motor 104 to drive actuator member 106 of actuator 103 away from mechanical stop 110 (and/or toward reference sensor 108) until reference sensor 108 is triggered by actuator member 106 as described herein with respect to step 502 of FIG. 5, and/or controller 102 may determine a position of electronically commutated motor 104 at which actuator member 106 of the actuator 103 triggered reference sensor 108 as described herein with respect to step 504 of FIG. 5. As an example, controller 102 may store, in the memory, the position (e.g., the trigger position, the stored position, etc.) of electronically commutated motor 104 at which actuator member 106 of actuator 103 triggered reference sensor 108 in response to triggering reference sensor 108 with actuator member 106 when driving actuator member 106 from an end of a current search distance toward reference sensor 108 as described herein in more detail.

As shown in FIG. 6, at step 604, process 600 includes controlling the electronically commutated motor to drive the actuator member a current search distance from the stored position toward the mechanical stop. For example, controller 102 may control electronically commutated motor 104 to drive actuator member 106 a current search distance from the stored position toward mechanical stop 110. As an example, controller 102 may control electronically commutated motor 104 to move a number of commutation steps corresponding to the current search distance to drive actuator member 106 from the stored position toward mechanical stop 110.

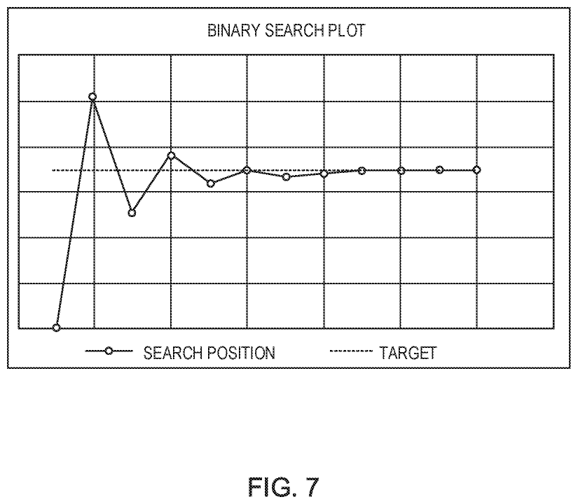

In some non-limiting embodiments or aspects, controller 102 may use a binary search algorithm to determine the current search distance itself, such as an initial search distance, and/or the like (and/or to determine a current incremental amount by which a current search distance may be increased and/or decreased as described herein). For example, and referring also to FIG. 7, which is a graph of a binary search plot, a binary search may compare a target value to a middle element of an array (e.g., the sequence of commutation steps or portions thereof, etc.) and, if they are not equal, the half in which the target cannot lie may be eliminated and the search continues on the remaining half, again taking the middle element to compare to the target value, and repeating this until the target value is found. If the search ends with the remaining half being empty, the target is not in the array (e.g., there is no mechanical stop 110 or obstruction present, etc.).

In some non-limiting embodiments or aspects, an initial search distance may include a predetermined search distance (e.g., a predetermined number of commutation steps, a predetermined number of full period driving sine waves, etc.).

As shown in FIG. 6, at step 606, process 600 includes controlling the electronically commutated motor to drive the actuator member from an end of the current search distance toward the reference sensor until the reference sensor is triggered by the actuator member. For example, controller 102 may control electronically commutated motor 104 to drive actuator member 106 from an end of the current search distance toward reference sensor 108 until reference sensor 108 is triggered by actuator member 106. As an example, controller 102 may control electronically commutated motor 104 to move a number of commutation steps or portions thereof toward reference sensor 108 until reference sensor 108 is triggered by actuator member 106.

As shown in FIG. 6, at step 608, process 600 includes, in response to triggering the reference sensor with the actuator member, comparing a current position of the electronically commutated motor at which the reference sensor is triggered by the actuator member to the stored position of the electronically commutated motor. For example, controller 102 may, in response to triggering reference sensor 108 with actuator member 106 (e.g., when driving actuator member 106 from the end of the current search distance toward reference sensor 108, etc.), compare a current position of electronically commutated motor 104 at which reference sensor 108 is triggered by actuator member 106 to the stored position of electronically commutated motor 104. As an example, controller 102 may compare a first number of commutation steps or portions thereof used to drive actuator member 106 from the stored position toward mechanical stop 110 to a second number of commutation steps or portions thereof used to drive actuator member 106 from the end of the current search distance until reference sensor 108 was triggered by actuator member 106. In such an example, controller may determine the first number of commutation steps or portions thereof and the second number of commutation steps or portions thereof by respectively counting a number of sine waves driving the stator coils of electronically commutated motor 104 in each direction.

As shown in FIG. 6, at step 610, process 600 includes, in response to determining that the current position of the electronically commutated motor is different than the stored position of the electronically commutated motor at step 608 of FIG. 6, determining that the actuator member encountered the mechanical stop, decreasing the current search distance a current incremental amount, and repeating steps 602 through 608 of FIG. 6. For example, controller 102 may, in response to determining that the current position of electronically commutated motor 104 is different than the stored position of electronically commutated motor 104 at step 608 of FIG. 6, determine that actuator member 106 encountered mechanical stop 110, decrease the current search distance a current incremental amount, and repeat steps 602 through 608 of FIG. 6.

A current incremental amount by which a current search distance may be increased and/or decreased may include at least a portion of a commutation step of electronically commutated motor 104 (e.g., at least a portion of commutation step, a microstep, a single commutation step, a plurality of commutation steps, etc.). Controller 102 may determine the current incremental amount for each iteration of process 600 (e.g., for each time it is determined to increase or decrease the current search distance by the current incremental amount, etc.). For example, the current incremental amount may be a dynamic value.

In some non-limiting embodiments or aspects, controller 102 may use a binary search algorithm as described herein to determine a current incremental amount by which a current search distance may be increased and/or decreased (and/or to determine the current search distance itself, such as an initial search distance, and/or the like).

In some non-limiting embodiments or aspects, a current incremental amount by which a current search distance may be increased and/or decreased may include a predetermined amount (e.g., a predetermined number of commutation steps, a single commutation step, at least a portion of a commutation step, etc.).

As shown in FIG. 6, at step 612, process 600 includes, in response to determining that the current position of the electronically commutated motor is the same as the stored position of the electronically commutated motor, determining whether the actuator member encountered the mechanical stop for the current search distance plus the current incremental amount. For example, controller 102 may, in response to determining that the current position of electronically commutated motor 104 is the same as the stored position of electronically commutated motor 104, determine whether actuator member 106 encountered mechanical stop 110 for the current search distance plus the current incremental amount (and/or whether a desired resolution/precision thereto has been achieved, etc.). As an example, controller 102 may determine whether mechanical stop 110 was encountered on a previous iteration of process 600.

As shown in FIG. 6, at step 614, process 600 includes, in response to determining that the actuator member did not encounter the mechanical stop at the current search distance plus the current incremental amount, increasing the current search distance by the current incremental amount and repeating 602 through 608 of FIG. 6. For example, controller 102 may, in response to determining that actuator member 106 did not encounter mechanical stop 110 at the current search distance plus the current incremental amount (e.g., did not encounter mechanical stop 110 on a previous iteration of process 600, etc.), increase the current search distance by the current incremental amount and repeat 602 through 608 of FIG. 6.

As shown in FIG. 6, at step 616, process 600 includes, in response to determining that the actuator member encountered the mechanical stop at the current search distance plus the current incremental amount, determining, based on the current search distance and the current search distance plus the current incremental amount, a distance for accurately positioning the actuator member relative to the mechanical stop. For example, controller 102 may, in response to determining that actuator member 106 encountered mechanical stop 110 at the current search distance plus the current incremental amount, determine, based on the current search distance and the current search distance plus the current incremental amount, a distance for accurately positioning actuator member 106 relative to mechanical stop 110. As an example, controller 102 may store, in the memory, the distance for accurately positioning the actuator member relative to the mechanical stop (e.g., as a calibrated value, etc.).

Various embodiments can be implemented, for example, using one or more computer systems, such as computer system 800 shown in FIG. 8. Computer system 800 can be any computer capable of performing the functions described herein.

Computer system 800 includes one or more processors (also called central processing units, or CPUs), such as a processor 804. Processor 804 is connected to a communication infrastructure or bus 806.

One or more processors 804 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 also includes user input/output device(s) 803, such as monitors, keyboards, pointing devices, etc., that communicate with communication infrastructure 806 through user input/output interface(s) 802.

Computer system 800 also includes a main or primary memory 808, such as random access memory (RAM). Main memory 808 may include one or more levels of cache. Main memory 808 has stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner.

According to an exemplary embodiment, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

In an embodiment, a tangible, non-transitory apparatus or article of manufacture comprising a tangible, non-transitory computer usable or readable medium having control logic (software) stored thereon is also referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A method for calibrating an actuator, comprising:
controlling, with at least one processor, an electronically commutated motor to drive an actuator member of the actuator away from a mechanical stop until a reference sensor is triggered by the actuator member;
determining, with the at least one processor, a position of the electronically commutated motor at which the actuator member of the actuator triggered the reference sensor;
controlling, with the at least one processor, the electronically commutated motor to repeatedly reciprocate the actuator member varying search distances from the position toward the mechanical stop and back to triggering the reference sensor until two reciprocated search distances from the position, which are at least a portion of a commutation step of the electronically commutated motor apart, are detected; and
determining, with the at least one processor, based on the two reciprocated search distances, a distance for accurately positioning the actuator member relative to the mechanical stop.

2. The method of claim 1, wherein the at least one processor uses a binary search algorithm to determine the varying search distances.

3. The method of claim 1, wherein the electronically commutated motor includes a stepper motor.

4. The method of claim 1, wherein the electronically commutated motor includes a rotary motor or a linear motor.

5. A method for calibrating an actuator, comprising:
(i) controlling, with at least one processor, an electronically commutated motor to drive an actuator member of the actuator away from a mechanical stop until a reference sensor is triggered by the actuator member;
(ii) storing, with the at least one processor, in a memory, a position of the electronically commutated motor at which the actuator member of the actuator triggered the reference sensor;
(iii) controlling, with the at least one processor, the electronically commutated motor to drive the actuator member a current search distance from the stored position toward the mechanical stop;
(iv) controlling, with the at least one processor, the electronically commutated motor to drive the actuator member from an end of the current search distance toward the reference sensor until the reference sensor is triggered by the actuator member;
(v) in response to triggering the reference sensor with the actuator member, comparing, with the at least one processor, a current position of the electronically commutated motor at which the reference sensor is triggered by the actuator member to the stored position of the electronically commutated motor; and
(vi) one of:
(a) in response to determining that the current position of the electronically commutated motor is different than the stored position of the electronically commutated motor, determining, with the at least one processor, that the actuator member encountered the mechanical stop, decreasing the current search distance a current incremental amount, and repeating steps (iii) (vi); and
(b) in response to determining that the current position of the electronically commutated motor is the same as the stored position of the electronically commutated motor, determining, with the at least one processor, whether the actuator member encountered the mechanical stop for the current search distance plus the current incremental amount and one of:
(1) in response to determining that the actuator member did not encounter the mechanical stop at the current search distance plus the current incremental amount, increasing, with the at least one processor, the current search distance by the current incremental amount and repeating steps (iii)-(vi); and
(2) in response to determining that the actuator member encountered the mechanical stop at the current search distance plus the current incremental amount, determining, with the at least one processor, based on the current search distance and the current search distance plus the current incremental amount, a distance for accurately positioning the actuator member relative to the mechanical stop.

6. The method of claim 5, wherein the current incremental amount includes at least one commutation step of the electronically commutated motor.

7. The method of claim 5, wherein the at least one processor uses a binary search algorithm to determine the current search distance and the current incremental amount.

8. The method of claim 5, wherein the electronically commutated motor includes a stepper motor.

9. The method of claim 5, wherein the electronically commutated motor includes a rotary motor or a linear motor.

10. The method of claim 5, further comprising:
storing, with the at least one processor, in the memory, the distance for accurately positioning the actuator member relative to the mechanical stop.

11. A system, comprising:
at least one processor coupled to a memory and configured to:
control an electronically commutated motor to drive an actuator member of an actuator away from a mechanical stop until a reference sensor is triggered by the actuator member;
determine a position of the electronically commutated motor at which the actuator member of the actuator triggered the reference sensor;
control the electronically commutated motor to repeatedly reciprocate the actuator member varying search distances from the position toward the mechanical stop and back to triggering the reference sensor until two reciprocated search distances from the position, which are at least a portion of a commutation step of the electronically commutated motor apart, are detected; and
determine, based on the two reciprocated search distances, a distance for accurately positioning the actuator member relative to the mechanical stop.

12. The system of claim 11, wherein the at least one processor is configured to use a binary search algorithm to determine the varying search distances.

13. The system of claim 11, wherein the electronically commutated motor includes a stepper motor.

14. The system of claim 11, wherein the electronically commutated motor includes a rotary motor or a linear motor.

15. A system, comprising:
at least one processor coupled to a memory and configured to:
(i) control an electronically commutated motor to drive an actuator member of an actuator away from a mechanical stop until a reference sensor is triggered by the actuator member;
(ii) store, in a memory, a position of the electronically commutated motor at which the actuator member of the actuator triggered the reference sensor;
(iii) control the electronically commutated motor to drive the actuator member a current search distance from the stored position toward the mechanical stop;
(iv) control the electronically commutated motor to drive the actuator member from an end of the current search distance toward the reference sensor until the reference sensor is triggered by the actuator member;
(v) in response to triggering the reference sensor with the actuator member, compare a current position of the electronically commutated motor at which the reference sensor is triggered by the actuator member to the stored position of the electronically commutated motor; and
(vi) one of:
(a) in response to determining that the current position of the electronically commutated motor is different than the stored position of the electronically commutated motor, determine that the actuator member encountered the mechanical stop, decreasing the current search distance a current incremental amount, and repeating steps (iii)-(vi); and
(b) in response to determining that the current position of the electronically commutated motor is the same as the stored position of the electronically commutated motor, determine whether the actuator member encountered the mechanical stop for the current search distance plus the current incremental amount and one of:
(1) in response to determining that the actuator member did not encounter the mechanical stop at the current search distance plus the current incremental amount, increase the current search distance by the current incremental amount and repeating steps (iii) (vi); and
(2) in response to determining that the actuator member encountered the mechanical stop at the current search distance plus the current incremental amount, determine, based on the current search distance and the current search distance plus the current incremental amount, a distance for accurately positioning the actuator member relative to the mechanical stop.

16. The system of claim 15, wherein the current incremental amount includes at least one commutation step of the electronically commutated motor.

17. The system of claim 15, wherein the at least one processor is configured to use a binary search algorithm to determine the current search distance and the current incremental amount.

18. The system of claim 15, wherein the electronically commutated motor includes a stepper motor.

19. The system of claim 15, wherein the electronically commutated motor includes a rotary motor or a linear motor.

20. The system of claim 15, wherein the at least one processor is further configured to:
store, in the memory, the distance for accurately positioning the actuator member relative to the mechanical stop.

21.-30. (canceled)
